(19) United States
(12) Patent Application Publication
(10) Pub. No.: US 2020/0339753 A1
(43) Pub. Date: Oct. 29, 2020

(54) POLYAMIDE ESTER AND PROCESS FOR ITS PRODUCTION

(71) Applicant: BASF SE, Ludwigshafen am Rhein (DE)

(72) Inventors: Christophe MOINEAU, Bron (FR); Jean-Francois THIERRY, Aubervillers (FR)

(73) Assignee: BASF SE, Ludwigshafen am Rhein (DE)

(21) Appl. No.: 16/956,303

(22) PCT Filed: Dec. 20, 2018
(86) PCT No.: PCT/EP2018/086160

§ 371 Date: Jun. 19, 2020

(30) Foreign Application Priority Data
Dec. 22, 2017 (EP) 17306905.5

(51) Int. Cl. C08G 69/44; C08L 77/12

(52) U.S. Cl. CPC C08G 69/44; C08L 77/12

(57) ABSTRACT

The present invention relates to a polyamide ester obtainable by polymerizing a polyamide salt, a polyhydric alcohol containing at least three hydroxyl groups, a dicarboxylic acid, and a chain limiting agent, wherein the polyhydric alcohol and the dicarboxylic acid are used in such amounts that the molar ratio of the excess of carboxylic acid groups from the dicarboxylic acid used to the molar equivalent amount of hydroxyl groups from the polyhydric alcohol used is at least 0.1.

### FIELD OF THE INVENTION

The present invention relates to the field of polyamides. In particular, the invention provides a novel polyamide ester and a process for its production.

### BACKGROUND

In the field of technical plastics, polymer compositions were often modified in order to impart advantageous properties to articles shaped therefrom or from compositions comprising them, the properties including mechanical strength, surface aspect, etc. Polymer compositions often comprise fillers intended to modify the mechanical properties or to reduce the costs of the material. For example, US 2009/0149590 A1 discloses a polymeric matrix having improved flowability and wettability, as well as a process for making it. The matrix contains a polyamide and a polyhydric alcohol which is chemically bonded at least to a part of the polyamide, and it is suitable particularly for manufacturing fiber-reinforced polyamide articles exhibiting a good surface appearance and mechanical properties.

On the other hand, it is well described that heat can be responsible for the thermo-oxidative degradation of polyamides, i.e. for the degradation of the polymer chain. In other words, after a long exposure to high temperature, the molecular weight of the polyamide is reduced compared to its original molecular weight with the consequence of the loss of mechanical properties like, for example, tensile strength.

It is also known that after a relatively short (in comparison with the lifetime of the polymeric article) exposure to high temperature, much before the thermo-oxidative degradation described in the previous paragraph, the first stage of evolution of the polyamide structure is an increase of molecular weight known as the post-condensation phenomenon.

Accordingly, in order to have a better heat resistance, a polyamide should be able to strongly post-condense during its early life at high temperature in order to strongly increase its molecular weight in order to delay the time of when its molecular weight will become lower than its original one due to the thermo-oxidative degradation.

So the aim of this invention is to obtain a polyamide having a strong molecular weight evolution during synthesis, which is indicative of its ability to strongly post-condense after a short time in contact with high temperatures.

The inventors of this application surprisingly found that a higher molar ratio of carboxylic acid groups to hydroxyl groups in the composition to be polymerized results in polyamide products which have an improved molecular weight evolution during synthesis and consequently have an improved ability to post-condense after exposure to high temperatures.

### SUMMARY OF THE INVENTION

The present invention therefore relates to the subject matter defined in the following items 1 to 46:

1. A polyamide ester obtainable by polymerisation of at least the following monomers:

a) a polyamide salt,

b) a polyhydric alcohol containing at least three hydroxyl groups,

c) a dicarboxylic acid, and

d) a chain limiting agent,

wherein the polyhydric alcohol and the dicarboxylic acid are used in such amounts that the molar ratio of the excess of carboxylic acid groups to the molar equivalent amount of hydroxyl groups from the polyhydric alcohol used is at least 0.1.

2. The polyamide ester of item 1, wherein the excess of carboxylic acid groups is the molar equivalent amount of carboxylic acid groups present in the composition to be polymerized, minus the molar amount of reactive amino groups present in the composition to be polymerized.

3. The polyamide ester of any one of the preceding items, wherein the polyamide salt is the salt of a diamine and a dicarboxylic acid. This dicarboxylic acid can be different from the monomer c).

4. The polyamide ester of any one of the preceding items, wherein the molar ratio of the diamine and the dicarboxylic acid in the polyamide salt is substantially 1.

5. The polyamide ester of any one of the preceding items, wherein the polyamide salt is hexamethylenediammonium adipate.

6. The polyamide ester of any one of the preceding items, wherein the polyhydric alcohol containing at least three hydroxyl groups is dipentaerythritol.

7. The polyamide ester of any one of the preceding items, wherein the dicarboxylic acid is adipic acid.

8. The polyamide ester of any one of the preceding items, wherein the chain-limiting agent is selected from the group consisting of monoacids, monoamines and combinations thereof.

9. The polyamide ester of any one of the preceding items, wherein the chain-limiting agent is selected from the group consisting of 3,5-di-t-butyl-4 hydroxyphenyl-propionic acid, acetic acid, 4-amino-2,2,6,6-tetramethylpiperidine and combinations thereof.

10. The polyamide ester of any one of the preceding items, wherein the chain-limiting agent comprises a monoacid.

11. The polyamide ester of any one of the preceding items, wherein the chain-limiting agent comprises acetic acid and/or 3,5-di-t-butyl-4 hydroxyphenyl-propionic acid.

12. The polyamide ester of any one of the preceding items, wherein the chain-limiting agent comprises a monoamine.

13. The polyamide ester of any one of the preceding items, wherein the chain-limiting agent comprises 4-amino-2,2,6,6-tetramethylpiperidine.

14. The polyamide ester of any one of items 1 to 11, wherein the chain-limiting agent is acetic acid.

15. The polyamide ester of any one of the preceding items, wherein the molar ratio of the excess of carboxylic acid groups to the molar equivalent amount of hydroxyl groups from the polyhydric alcohol used is at least 0.2.

16. The polyamide ester of any one of the preceding items, wherein the molar ratio of the excess of carboxylic acid groups to the molar equivalent amount of hydroxyl groups from the polyhydric alcohol used is at least 0.3.

17. The polyamide ester of any one of the preceding items, wherein the molar ratio of the excess of carboxylic acid groups to the molar equivalent amount of hydroxyl groups from the polyhydric alcohol used is at least 0.4.

18. The polyamide ester of any one of the preceding items, wherein the molar ratio of the excess of carboxylic acid groups to the molar equivalent amount of hydroxyl groups from the polyhydric alcohol used is at least 0.45.

19. The polyamide ester of any one of the preceding items, which exhibits a viscosity index of at least 90 ml/g.

20. The polyamide ester of any one of the preceding items, which exhibits a viscosity index of at least 120 ml/g.

21. The polyamide ester of any one of the preceding items, which exhibits a viscosity index of at least 150 ml/g.

22. A process for the manufacture of a polyamide ester, comprising the following steps:

(i) providing a composition comprising a polyamide salt, a polyhydric alcohol containing at least three hydroxyl groups, a dicarboxylic acid, and a chain-limiting agent, wherein the polyhydric alcohol and the dicarboxylic acid are used in such amounts that the molar ratio of the excess of carboxylic acid groups to the molar equivalent amount of hydroxyl groups from the polyhydric alcohol is at least 0.1; and

(ii) polymerizing the composition obtained in step (i).

23. The process of item 22, wherein the excess of carboxylic acid groups is the molar amount of carboxylic acid groups present in the composition to be polymerized, minus the molar amount of reactive amino groups present in the composition to be polymerized.

24. The process of item 22 or 23, wherein the composition further comprises an antifoaming agent.

25. The process of any one of items 22 to 24, wherein the antifoaming agent is a polydimethylsiloxane-based compound.

26. The process of any one of items 22 to 25, wherein said polymerizing comprises heating the composition under pressure greater than atmospheric pressure.

27. The process of any one of items 22 to 26, further comprising melt-extruding the polymerized composition obtained from step (ii).

28. The process of item 27 wherein the viscosity index of the polymerized composition increases by at least 5%, or at least 10%, or at least 15%, within the first 10 minutes of melt extrusion.

29. The process of any one of items 22 to 28, wherein the polyamide salt is the salt of a diamine and a dicarboxylic acid.

30. The process of item 29, wherein the molar ratio of the diamine and the dicarboxylic acid in the polyamide salt is substantially 1.

31. The process of any one of items 22 to 30, wherein the polyamide salt is hexamethylenediammonium adipate.

32. The process of any one of items 22 to 31, wherein the polyhydric alcohol containing at least three hydroxyl groups is dipentaerythritol.

33. The process of any one of items 22 to 32, wherein the dicarboxylic acid is adipic acid.

34. The process of any one of items 22 to 33, wherein the chain-limiting agent is selected from the group consisting of monoacids, molecules with only one reactive amine function and combinations thereof.

35. The process of any one of items 22 to 34, wherein the chain-limiting agent is selected from the group consisting of 3,5-di-t-butyl-4 hydroxyphenyl-propionic acid, acetic acid, 4-amino-2,2,6,6-tetramethylpiperidine and combinations thereof.

36. The process of any one of items 22 to 35, wherein the chain-limiting agent comprises a monoacid.

37. The process of any one of items 22 to 36, wherein the chain-limiting agent comprises acetic acid and/or 3,5-di-t-butyl-4 hydroxyphenyl-propionic acid.

38. The process of any one of items 22 to 37, wherein the chain-limiting agent comprises a molecule with only one reactive amine function.

39. The process of any one of items 22 to 36, wherein the chain-limiting agent comprises 4-amino-2,2,6,6-tetramethylpiperidine

40. The process of any one of items 22 to 35, wherein the chain-limiting agent is acetic acid.

41. The process of any one of items 22 to 40, wherein the molar ratio of the excess of carboxylic acid groups to the molar equivalent amount of hydroxyl groups from the polyhydric alcohol used is at least 0.2.

42. The process of any one of items 22 to 40, wherein the molar ratio of the excess of carboxylic acid groups to the molar equivalent amount of hydroxyl groups from the polyhydric alcohol used is at least 0.3.

43. The process of any one of items 22 to 40, wherein the molar ratio of the excess of carboxylic acid groups to the molar equivalent amount of hydroxyl groups from the polyhydric alcohol used is at least 0.4.

44. The process of any one of items 22 to 40, wherein the molar ratio of the excess of carboxylic acid groups to the molar equivalent amount of hydroxyl groups from the polyhydric alcohol used is at least 0.45.

45. A polyamide ester obtainable by the process of any one of items 22 to 44.

46. The polyamide ester of item 45, which is the polyamide ester as defined in any one of items 1 to 21.

### DRAWINGS

FIG. 1 depicts the results of the examples also shown in Table 2. “VI” means viscosity index.

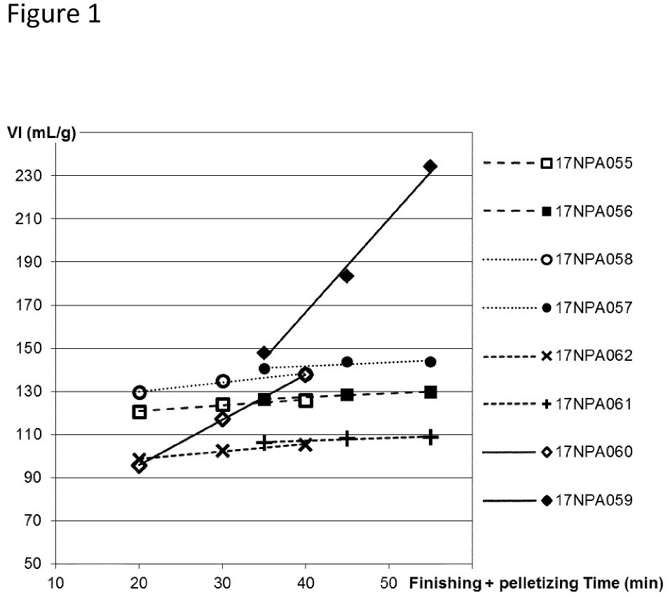

### DETAILED DESCRIPTION

The present invention relates to a novel polyamide ester obtainable by polymerizing at least the following components:

a) a polyamide salt,

b) a polyhydric alcohol containing at least three hydroxyl groups,

c) a dicarboxylic acid, and

d) a chain limiting agent.

The polyhydric alcohol and the dicarboxylic acid are used in such amounts that the molar ratio of the excess of carboxylic acid groups to the molar equivalent amount of hydroxyl groups from the polyhydric alcohol used is at least 0.1. Preferably, said molar ratio is at least 0.2, or at least 0.3, or at least 0.4. Most preferably, it is at least 0.45. The term “excess of carboxylic acid groups” refers to the molar amount of carboxylic acid groups present in the composition to be polymerized, minus the molar amount of reactive amino groups present in the composition to be polymerized.

This excess, particularly when it is high, increases the potential for reaction between the carboxylic acid groups and the hydroxyl groups.

This will improve the aging properties of the polymer. Indeed the ester linkages will form branching, which branching will reduce the impact of the thermo-oxidative degradation of the polymer.

The term “polyamide” as used herein includes homopolyamides that are obtainable by polymerizing one monomer such as an aminocarboxylic acid, as well as homopolyamides that are obtainable by polymerizing two different monomers (one of the diacid type and one of the diamine type). It also includes copolyamides obtainable by polymerizing a combination of all monomers cited above for homopolyamides, and copolyamides obtainable by polymerizing at least 3 monomers, of which at least 2 different diacids and/or at least 2 different diamines. The polyamide ester of the present invention is preferably based on a homopolyamide from diacid and diamine or based on a copolyamide obtainable by polymerizing at least 3 monomers, of which at least 2 different diacids and/or at least 2 different diamines.

The term “polyamide salt”, as used herein, refers to a salt of one or more monomers that can be polymerized to obtain a polyamide. In one embodiment, the polyamide salt is the salt of an aminocarboxylic acid. In another embodiment, the polyamide salt is the salt of a diamine and of a dicarboxylic acid. The dicarboxylic acid may be selected from the group consisting of adipic acid, sebacic acid, suberic acid, dodecanedioic acid, azelaic acid, terephthalic acid, isophthalic acid, 5-sulfoisophthalic acid, glutaric acid, dimer acid, cyclohexane dicarboxylic acid, 2,6-naphthalene dicarboxylic acid, tert-butyl isophthalic acid, and phenylindanedicarboxylic acid.

The dicarboxylic acid can also be a polyetherdiacid, such as polyethylene glycol diacid or polypropyleneglycol diacid.

The dicarboxylic acid cans also be a diacid with a non-aromatic cycle, a diacid with a furfuryl cycle, a diacid having 11 to 16 carbon atoms, or a diacid having 14 carbon atoms.

Most preferably, the dicarboxylic acid is adipic acid.

The diamine may be selected from the group consisting of hexamethylene diamine, tetramethylene diamine, pentamethylene diamine, 2-methyl pentamethylene diamine, 3,3′-dimethyl-4,4′-diaminodicyclohexylmethane, 1,6-diamino-2,2,4-trimethylhexane, m-xylylenediamine, p-xylylenediamine, diaminononane, diaminodecane, diaminododecane, 2,2-bis(p-aminocyclohexyl)propane, bis(p-aminocyclohexyl)methane, isophoronediamine, polypropyleneglycoldiamine, norbornanediamine, and 1,3-bis(aminomethyl)cyclopentane.

The diamine can also be a polyetherdiamine, such as polyethylene glycol diamine or polypropyleneglycol diamine.

The diamine cans also be a diamine with a non-aromatic cycle or a diamine with a furfuryl cycle.

Preferably the diamine is hexamethylene diamine.

Most preferably, the polyamide salt is the salt of adipic acid and of hexamethylene diamine. Said salt is also referred to as hexamethylene diammonium adipate.

Other suitable polyamide salts are those of sebacic acid (or decanedioic acid) and of hexamethylene diamine, those of dodecanedioic acid and hexamethylene diamine, and those of adipic acid, terephthalic acid and hexamethylene diamine. Other examples of suitable polyamide salts are those resulting in polyamides containing more than 50% of units (diamine-aromatic diacid) or (aromatic diacid-diamine).

It is further preferred that, if the polyamide salt comprises or consists of two different monomers, the two monomers are present in said salt in substantially equimolar amounts. That is, the molar ratio of the first monomer to the second monomer in the polyamide salt is substantially 1. Preferably, the molar ratio of the diamine to the dicarboxylic acid in the polyamide salt is substantially 1.

The “polyamide salt” can also be mixture of monomers, for instance a mixture of a diamine and a dicarboxylic acid, the two monomers being present in substantially equimolar amounts.

It can be a mixture of monomers which will form a copolymer, for instance a mixture of a salt of adipic acid and of hexamethylene diamine, with caprolactam.

The monomers can also be lactams (such as caprolactam, lauryllactam etc.) or omega aminoacids (having for instance 6, 11 or 12 carbon atoms).

The polyhydric alcohol containing at least three hydroxyl groups may be selected, for example, from the group consisting of trimethylolethane, trimethylolpropane, trimethylolbutane, pentaerythritol, dipentaerythritol, ditrimethylolpropane, erythritol, mesoerythritol, inositol, sorbitol, D-mannitol, xylitol, galactitol, altritol, iditol, ribitol, D-arabitol, glucose, lactose, fructose, sucrose, mixtures thereof, and derivatives thereof capable of supplying polyhydric alcohol to a polymerization medium of said polyamide as a result of a chemical change.

Most preferably, the polyhydric alcohol containing at least three hydroxyl groups is dipentaerythritol.

The dicarboxylic acid referred in item c) above is preferably adipic acid.

The chain limiting agent present in the composition to be polymerized is typically selected from the group consisting of monoacids, monoamines and combinations thereof. In one embodiment, the chain limiting agent comprises a monoacid, e.g. acetic acid. In another embodiment, the chain limiting agent consists of a monoacid, e.g. of acetic acid. In yet another embodiment, the chain limiting agent is selected from the group consisting of 3,5-di-t-butyl-4 hydroxyphenyl-propionic acid, acetic acid, 4-amino-2,2,6,6-tetramethylpiperidine and combinations thereof. In yet another embodiment, the chain limiting agent comprises or consists of 3,5-di-t-butyl-4 hydroxyphenyl-propionic acid, acetic acid and 4-amino-2,2,6,6-tetramethylpiperidine.

In yet another embodiment, the chain limiting agent comprises a molecule with only one reactive amine function, e.g. 4-amino-2,2,6,6-tetramethylpiperidine or benzylamine.

The chain limiting agent is important, particularly when the excess of carboxylic acid group mentioned above is high (more particularly when it is at least 0.45).

Indeed, when the excess is high, due to the formation of many ester linkages, the polymer is evolving (i.e the viscosity index can increase) during its synthesis or during subsequent processing steps, thus making the viscosity control more difficult.

Thanks to the chain limiting agent, the polymer viscosity evolves less quickly during synthesis and processing steps. So the process can be better controlled, while preserving the potential of formation of ester linkages (brought by the high excess of carboxylic acid groups).

The invention also provides a process for the manufacture of a polyamide ester as defined above, said process comprising polymerizing a composition comprising a polyamide salt, a polyhydric alcohol containing at least three hydroxyl groups, a dicarboxylic acid and a chain limiting agent, wherein the polyhydric alcohol and the dicarboxylic acid are used in such amounts that the molar ratio of the excess of carboxylic acid groups to the molar equivalent amount of hydroxyl groups is at least 0.1.

The composition to be polymerized may further comprise an antifoaming agent, e.g. a polydimethylsiloxane-based compound.

The polymerization itself is carried out according to techniques known in the art. This is typically done by heating the composition to be polymerized in a suitable reactor or autoclave. Preferably, said heating is carried out under more than atmospheric pressure, e.g. at an absolute pressure of 3 to 30 bar, more preferably from 10 to 20 bar.

After the polymerization, the reactor/autoclave is usually decompressed. After this period of decompression, the polymerization typically continues, which is part of the finishing step.

After the finishing phase, the polymerized composition may be melt-extruded from the reactor/autoclave according to techniques that are known in the art.

The viscosity index of the polymerized composition preferably increases by at least 5% within the first 10 minutes of melt extrusion. Preferably, the viscosity index of the polymerized composition increases by at least 10% within the first 10 minutes of melt extrusion. Most preferably, the viscosity index of the polymerized composition increases by at least 15% within the first 10 minutes of melt extrusion. In one embodiment, the increase in the viscosity index during the first 10 minutes of melt extrusion in in the range from 5% to 30%, or from 5% to 25%, or from 5% to 20%, or from 5% to 15%.

The standard ISO 307 defines the protocol for measuring the viscosity index, also called viscosity number, according to the measurement of the flow times, at 25° C., of a polyamide solution. When the polyamide is a polyamide 66 or 6, a solution with a content by weight of 5 gain 90% formic acid is used. Unless indicated otherwise, the viscosity index, as used herein, refers to the viscosity index determined according to ISO 307.

The preferred embodiments of the process of the invention correspond to the preferred embodiments of the polyamide ester of the present invention as described hereinabove.

The present invention further relates to a polyamide ester obtainable by the process described herein.

### EXAMPLES

### 17NPA055 (Comparative Example)

In a polymerisation reactor, 140.060 g of nylon 66 salt prepared from hexamethylenediamine and adipic acid, was added with 132.650 g of demineralized water forming a solution with a pH of 7.6. Then, were added to this solution, 0.102 g of Adipic Acid (Solvay, purity 100%), 0.701 g of Pentaerythritol (Aldrich, purity 98%), 0.059 g of Sodium hypophosphite monohydrate (purity >99%), 0.159 g of 4-amino-2,2,6,6-tetramethylpiperidine (Aldrich, purity 98%), 0.179 g of 3,5-di-tertbutyl-4-hydroxyphenyl-propionic acid (CIBA, purity >99%) and 2 g of a polydimethylsiloxane-based antifoam agent.

Then the polymerisation occurred with a standard PA66 polymerisation process with 20 min of finishing time at a pressure of 1 bar absolute and a temperature of 275° C.

Finally, the polymer melt was extruded from the polymerisation reactor into strand, cooled, and cut into pellets. Three samples were collected at 3 different times of extrusion: 0 min, 10 min and 20 min. These polymer samples are referred to as 17NPA055-1, 17NPA055-2 and 17NPA055-3 in Table 2.

### 17NPA056 (Comparative Example)

In a polymerisation reactor, 140.050 g of nylon 66 salt prepared from hexamethylenediamine and adipic acid, was added with 132.630 g of demineralized water forming a solution with a pH of 7.6. Then, were added to this solution, 0.106 g of Adipic Acid (Solvay, purity 100%), 0.716 g of Pentaerythritol (Aldrich, purity 98%), 0.060 g of Sodium hypophosphite monohydrate (purity >99%), 0.161 g of 4-amino-2,2,6,6-tetramethylpiperidine (Aldrich, purity 98%), 0.177 g of 3,5-di-tertbutyl-4-hydroxyphenyl-propionic acid (CIBA, purity >99%) and 2 g of antifoam agent.

Then the polymerisation occurred with a standard PA66 polymerisation process with 35 min of finishing time at an absolute pressure of 1 bar and a temperature of 275° C.

Finally, the polymer melt was extruded from the polymerisation reactor into strand, cooled, and cut into pellets. Three samples were collected at 3 different times of extrusion: 0 min, 10 min and 20 min. These polymer samples are referred to as 17NPA056-1, 17NPA056-2 and 17NPA056-3 in Table 2.

### 17NPA057 (Comparative Example)

In a polymerisation reactor, 140.040 g of nylon 66 salt prepared from hexamethylenediamine and adipic acid, was added with 132.620 g of demineralized water forming a solution with a pH of 7.6. Then, were added to this solution, 0.110 g of Adipic Acid (Solvay, purity 100%), 0.872 g of DiPentaerythritol (Perstorp, purity 97%), 0.059 g of Sodium hypophosphite monohydrate (purity >99%), 0.161 g of 4-amino-2,2,6,6-tetramethylpiperidine (Aldrich, purity 98%), 0.180 g of 3,5-di-tertbutyl-4-hydroxyphenyl-propionic acid (CIBA, purity >99%) and 2 g of antifoam agent.

Then the polymerisation occurred with a standard PA66 polymerisation process with 35 min of finishing time at an absolute pressure of 1 bar and a temperature of 275° C.

Finally, the polymer melt was extruded from the polymerisation reactor into strand, cooled, and cut into pellets. Three samples were collected at 3 different times of extrusion: 0 min, 10 min and 20 min. These polymer samples are referred to as 17NPA057-1, 17NPA057-2 and 17NPA057-3 in Table 2.

### 17NPA058 (Comparative Example)

In a polymerisation reactor, 140.040 g of nylon 66 salt prepared from hexamethylenediamine and adipic acid, was added with 132.620 g of demineralized water forming a solution with a pH of 7.6. Then, were added to this solution, 0.107 g of Adipic Acid (Solvay, purity 100%), 0.881 g of DiPentaerythritol (Perstorp, purity 97%), 0.059 g of Sodium hypophosphite monohydrate (purity >99%), 0.161 g of 4-amino-2,2,6,6-tetramethylpiperidine (Aldrich, purity 98%), 0.176 g of 3,5-di-tertbutyl-4-hydroxyphenyl-propionic acid (CIBA, purity >99%) and 2 g of antifoam agent.

Then the polymerisation occurred with a standard PA66 polymerisation process with 20 min of finishing time at an absolute pressure of 1 bar and a temperature of 275° C.

Finally, the polymer melt was extruded from the polymerisation reactor into strand, cooled, and cut into pellets. Three samples were collected at 3 different times of extrusion: 0 min, 10 min and 20 min. These polymer samples are referred to as 17NPA058-1, 17NPA058-2 and 17NPA058-3 in Table 2.

### 17NPA059 (Example According to the Invention)

In a polymerisation reactor, 140.030 g of nylon 66 salt prepared from hexamethylenediamine and adipic acid, was added with 132.620 g of demineralized water forming a solution with a pH of 7.6. Then, were added to this solution, 3.020 g of Adipic Acid (Solvay, purity 100%), 3.800 g of DiPentaerythritol (Perstorp, purity 97%), 0.243 g of Acetic Acid (VWR, purity 99%) and 2 g of antifoam agent.

Then the polymerisation occurred with a standard PA66 polymerisation process with 35 min of finishing time at an absolute pressure of 1 bar and a temperature of 275° C.

Finally, the polymer melt was extruded from the polymerisation reactor into strand, cooled, and cut into pellets. Three samples were collected at 3 different times of extrusion: 0 min, 10 min and 20 min. These polymer samples are referred to as 17NPA059-1, 17NPA059-2 and 17NPA059-3 in Table 2.

### 17NPA060 (Example According to the Invention)

In a polymerisation reactor, 140.040 g of nylon 66 salt prepared from hexamethylenediamine and adipic acid, was added with 132.700 g of demineralized water forming a solution with a pH of 7.6. Then, were added to this solution, 3.020 g of Adipic Acid (Solvay, purity 100%), 3.800 g of DiPentaerythritol (Perstorp, purity 97%), 0.243 g of Acetic Acid (VWR, purity 99%) and 2 g of antifoam agent.

Then the polymerisation occurred with a standard PA66 polymerisation process with 20 min of finishing time at an absolute pressure of 1 bar and a temperature of 275° C.

Finally, the polymer melt was extruded from the polymerisation reactor into strand, cooled, and cut into pellets. Three samples were collected at 3 different times of extrusion: 0 min, 10 min and 20 min. These polymer samples are referred to as 17NPA060-1, 17NPA060-2 and 17NPA060-3 in Table 2.

### 17NPA061 (Comparative Example)

In a polymerisation reactor, 140.050 g of nylon 66 salt prepared from hexamethylenediamine and adipic acid, was added with 132.600 g of demineralized water forming a solution with a pH of 7.6. Then, were added to this solution, 0.369 g of Adipic Acid (Solvay, purity 100%), 3.799 g of DiPentaerythritol (Perstorp, purity 97%), 0.059 g of Sodium hypophosphite monohydrate (purity >99%), 0.161 g of 4-amino-2,2,6,6-tetramethylpiperidine (Aldrich, purity 98%), 0.176 g of 3,5-di-tertbutyl-4-hydroxyphenyl-propionic acid (CIBA, purity >99%) and 2 g of antifoam agent.

Then the polymerisation occurred with a standard PA66 polymerisation process with 35 min of finishing time at an absolute pressure of 1 bar and a temperature of 275° C.

Finally, the polymer melt was extruded from the polymerisation reactor into strand, cooled, and cut into pellets. Three samples were collected at 3 different times of extrusion: 0 min, 10 min and 20 min. These polymer samples are referred to as 17NPA061-1, 17NPA061-2 and 17NPA061-3 in Table 2.

### 17NPA062 (Comparative Example)

In a polymerisation reactor, 140.050 g of nylon 66 salt prepared from hexamethylenediamine and adipic acid, was added with 132.600 g of demineralized water forming a solution with a pH of 7.6. Then, were added to this solution, 0.369 g of Adipic Acid (Solvay, purity 100%), 3.799 g of DiPentaerythritol (Perstorp, purity 97%), 0.059 g of Sodium hypophosphite monohydrate (purity >99%), 0.161 g of 4-amino-2,2,6,6-tetramethylpiperidine (Aldrich, purity 98%), 0.176 g of 3,5-di-tertbutyl-4-hydroxyphenyl-propionic acid (CIBA, purity >99%) and 2 g of antifoam agent.

Then the polymerisation occurred with a standard PA66 polymerisation process with 20 min of finishing time at an absolute pressure of 1 bar and a temperature of 275° C.

Finally, the polymer melt was extruded from the polymerisation reactor into strand, cooled, and cut into pellets. Three samples were collected at 3 different times of extrusion: 0 min, 10 min and 20 min. These polymer samples are referred to as 17NPA062-1, 17NPA062-2 and 17NPA062-3 in Table 2.

Table 1 summarizes the details of the components of the composition to be polymerized. The Excess of Carboxylic group is based on the addition of 2 times the number of mol of Adipic Acid (2 carboxylic functions per molecule) with the number of mol of 3,5-di-t-butyl-4 hydroxyphenyl-propionic acid and acetic acid (1 carboxylic functions per molecule) subtracted by the number of mol of 4-amino-2,2,6,6-tetramethylpiperidine (1 active amine function per molecule).

Total Chain Cutter is based on the addition of mol of monofunctional molecules that are 3,5-di-t-butyl-4 hydroxyphenyl-propionic acid, acetic acid and 4-amino-2,2,6,6-tetramethylpiperidine

The viscosity index of all samples was determined according to ISO 307 International Standard, in solution in 90% formic acid. The results are summarized in Table 2.

TABLE 1

| | Unit | 17NPA055 | 17NPA056 | 17NPA057 | 17NPA058 | 17NPA059 | 17NPA060 | 17NPA061 | 17NPA062 |
|---|---|---|---|---|---|---|---|---|---|
| Nylon 66 Salt | g | 140.060 | 140.050 | 140.040 | 140.040 | 140.030 | 140.040 | 140.050 | 140.050 |
| | mol | 0.534 | 0.534 | 0.534 | 0.534 | 0.534 | 0.534 | 0.534 | 0.534 |
| DiPentaErythritol | g | | | 0.872 | 0.881 | 3.800 | 3.800 | 3.799 | 3.799 |
| | mol | | | 3.43E−03 | 3.46E−03 | 1.49E−02 | 1.49E−02 | 1.49E−02 | 1.49E−02 |
| PentaErythritol | g | 0.701 | 0.716 | | | | | | |
| | mol | 5.15E−03 | 5.26E−03 | | | | | | |
| Adipic Acid | g | 0.102 | 0.106 | 0.110 | 0.107 | 3.020 | 3.020 | 0.369 | 0.369 |
| | mol | 6.98E−04 | 7.22E−04 | 7.53E−04 | 7.29E−04 | 2.07E−02 | 2.07E−02 | 2.52E−03 | 2.52E−03 |
| 4-amino-2,2,6,6- | g | 0.159 | 0.161 | 0.161 | 0.161 | | | 0.161 | 0.161 |
| tetramethylpiperidine | mol | 1.02E−03 | 1.03E−03 | 1.03E−03 | 1.03E−03 | | | 1.03E−03 | 1.03E−03 |
| 3,5-di-t-butyl-4- | g | 0.179 | 0.177 | 0.180 | 0.176 | | | 0.176 | 0.176 |
| hydroxyphenyl- | mol | 6.43E−04 | 6.35E−04 | 6.47E−04 | 6.34E−04 | | | 6.31E−04 | 6.31E−04 |
| propionic acid | | | | | | | | | |
| Acetic acid | g | | | | | 0.243 | 0.243 | | |
| | mol | | | | | 4.05E−03 | 4.05E−03 | | |
| Sodium hypophosphite | g | 0.059 | 0.060 | 0.059 | 0.059 | | | 0.059 | 0.059 |
| Monohydrate | | | | | | | | | |
| Water | g | 132.650 | 132.630 | 132.620 | 132.620 | 132.620 | 132.700 | 132.600 | 132.600 |
| Anti Foam | g | 2.006 | 2.003 | 2.007 | 2.023 | 2.007 | 2.085 | 2.013 | 2.013 |
| Molar equivalent | mol | 0.021 | 0.021 | 0.021 | 0.021 | 0.090 | 0.090 | 0.090 | 0.090 |
| amount of OH from | | | | | | | | | |
| DiPentaErythritol or | | | | | | | | | |
| PentaErythritol eq. | | | | | | | | | |
| Excess of Carboxylic | mol | 1.02E−03 | 1.05E−03 | 1.12E−03 | 1.06E−03 | 4.54E−02 | 4.54E−02 | 4.65E−03 | 4.65E−03 |
| Group | | | | | | | | | |
| Ratio between Excess | | 0.05 | 0.05 | 0.05 | 0.05 | 0.51 | 0.51 | 0.05 | 0.05 |
| of Carboxylic Group in | | | | | | | | | |
| the recipe and Molar | | | | | | | | | |
| equivalent amount of | | | | | | | | | |
| OH | | | | | | | | | |
| Total Chain cutter | mol | 1.66E−03 | 1.66E−03 | 1.68E−03 | 1.67E−03 | 4.05E−03 | 4.05E−03 | 1.66E−03 | 1.66E−03 |
| Finishing time | min | 20 | 35 | 35 | 20 | 35 | 20 | 35 | 20 |

TABLE 2

| Poly- | | Finishing | Extrusion | Extrusion + | |
|---|---|---|---|---|---|
| merization | Sample after | Time | Time | pelletizing | VI |
| recipe | extrusion | (min) | (min) | Time (min) | mL/g |
| 17NPA055 | 17NPA055-1 | 20 | 0 | 20 | 120.4 |
| | 17NPA055-2 | 20 | 10 | 30 | 124.1 |
| | 17NPA055-3 | 20 | 20 | 40 | 126.0 |
| 17NPA056 | 17NPA056-1 | 35 | 0 | 35 | 126.2 |
| | 17NPA056-2 | 35 | 10 | 45 | 128.5 |
| | 17NPA056-3 | 35 | 20 | 55 | 129.6 |
| 17NPA057 | 17NPA057-1 | 35 | 0 | 35 | 140.5 |
| | 17NPA057-2 | 35 | 10 | 45 | 143.5 |
| | 17NPA057-3 | 35 | 20 | 55 | 143.8 |
| 17NPA058 | 17NPA058-1 | 20 | 0 | 20 | 129.5 |
| | 17NPA058-2 | 20 | 10 | 30 | 134.8 |
| | 17NPA058-3 | 20 | 20 | 40 | 138.0 |
| 17NPA059 | 17NPA059-1 | 35 | 0 | 35 | 147.8 |
| | 17NPA059-2 | 35 | 10 | 45 | 183.4 |
| | 17NPA059-3 | 35 | 20 | 55 | 234.3 |
| 17NPA060 | 17NPA060-1 | 20 | 0 | 20 | 95.7 |
| | 17NPA060-2 | 20 | 10 | 30 | 117.0 |
| | 17NPA060-3 | 20 | 20 | 40 | 137.6 |
| 17NPA061 | 17NPA061-1 | 35 | 0 | 35 | 106.1 |
| | 17NPA061-2 | 35 | 10 | 45 | 108.2 |
| | 17NPA061-3 | 35 | 20 | 55 | 108.8 |
| 17NPA062 | 17NPA062-1 | 20 | 0 | 20 | 98.5 |
| | 17NPA062-2 | 20 | 10 | 30 | 102.5 |
| | 17NPA062-3 | 20 | 20 | 40 | 105.2 |

It can be seen that in examples 17NPA055 and 17NPA056 having the same polymer recipe than the one of example 9N of the patent application US 2009/0149590A and where a monomer with a functionality of 4 is used under the name of PentaErythritol, the molecular weight evolution, expressed as the viscosity index measurement, during synthesis and during granulation is quite low.

The same observation was made in examples 17NPA057 and 17NPA058 where the monomer of functionality 4 is replaced by a monomer of functionality 6 under the name of DiPentaErythritol keeping all other parameters constant that mean the number of hydroxyl function coming from PentaErythritol or DiPentaErythritol, the ratio between excess of carboxylic group in the recipe and the number of hydroxyl and the total chain cutter content.

Surprisingly, in examples 17NPA061 and 17NPA062, keeping these same parameters constant except increasing the total amount of DiPentaErythritol in order to improve the molecular weight evolution during synthesis, we finally observed that the molecular weight evolution is not improved and worse, the obtained molecular weights are lower.

This means that such type of recipe described in the patent application US 2009/0149590A cannot sufficiently improve the polyamide properties in terms of molecular weight evolution.

In the opposite, the present invention based on the polymer recipe described in examples 17NPA059 and 17NPA060, offer the possibility to improve the molecular weight evolution which is, as explained earlier, the necessary condition to get satisfying heat resistance properties.

1. A polyamide ester obtained by polymerizing at least the following monomers:
a polyamide salt,
a polyhydric alcohol comprising at least three hydroxyl groups,
a dicarboxylic acid, and
a chain limiting agent,
wherein the polyhydric alcohol and the dicarboxylic acid are used in such amounts that a molar ratio of an excess of carboxylic acid groups to a molar equivalent amount of hydroxyl groups from the polyhydric alcohol is at least 0.1.

2. The polyamide ester of claim 1, wherein the polyamide salt is hexamethylenediammonium adipate.

3. The polyamide ester of claim 1, wherein the polyhydric alcohol comprising at least three hydroxyl groups is dipentaerythritol.

4. The polyamide ester of claim 1, wherein the dicarboxylic acid is adipic acid.

5. The polyamide ester of claim 1, wherein the chain-limiting agent is at least one selected from the group consisting of monoacids and molecules with only one reactive amine function.

6. The polyamide ester of claim 1, wherein the chain-limiting agent is acetic acid.

7. The polyamide ester of claim 1, wherein the molar ratio of the excess of carboxylic acid groups to the molar equivalent amount of hydroxyl groups from the polyhydric alcohol used is at least 0.2.

8. The polyamide ester of claim 1, which exhibits a viscosity index of at least 90 mL/g.

9. A process for the manufacture of a polyamide ester, comprising:
providing a composition, comprising:
a polyamide salt,
a polyhydric alcohol comprising at least three hydroxyl groups,
a dicarboxylic acid, and
a chain-limiting agent,
wherein the polyhydric alcohol and the dicarboxylic acid are used in such amounts that a molar ratio of the number of carboxylic acid groups from the dicarboxylic acid used to the number of hydroxyl groups from the polyhydric alcohol used is at least 0.1; and
polymerizing the composition.

10. The process of claim 9, wherein the composition further comprises an antifoaming agent.

11. The process of claim 9, wherein said polymerizing comprises heating the composition under a pressure greater than atmospheric pressure.

12. The process of claim 9,
wherein the polymerizing produces a polymerized composition, and
wherein the process further comprises melt-extruding the polymerized composition.

13. The process of claim 12, wherein a viscosity index of the polymerized composition increases by at least 10% within the first 10 minutes of the melt-extruding.

14. A polyamide ester obtained by the process of claim 9.

15. (canceled)
